(19) United States
(12) Patent Application Publication
(10) Pub. No.: US 2026/0302066 A1
(43) Pub. Date: Oct. 1, 2026

(54) MULTILAYER ELECTRONIC COMPONENT

(71) Applicant: SAMSUNG ELECTRO-MECHANICS CO., LTD., Suwon-si (KR)

(72) Inventor: Woo Seok KANG, Suwon-si (KR)

(73) Assignee: SAMSUNG ELECTRO-MECHANICS CO., LTD., Suwon-si (KR)

(21) Appl. No.: 19/569,212

(22) Filed: Mar. 17, 2026

(30) Foreign Application Priority Data
Mar. 27, 2025 (KR) 10-2025-0039503

(51) Int. Cl. H01G 4/12; H01G 4/224; H01G 4/232; H01G 4/30; H01G 4/248

(52) U.S. Cl. CPC H01G 4/1227; H01G 4/224; H01G 4/232; H01G 4/30; H01G 4/248

(57) ABSTRACT

A multilayer electronic component includes a body having a dielectric layer containing dielectric grains, internal electrodes, and a capacitance‑forming portion in which the dielectric layer and the internal electrodes are alternately stacked. External electrodes are disposed on the body and electrically connected to the internal electrodes. The dielectric grains include first grains having an aspect ratio of less than 1:5 and second grains having an aspect ratio of 1:5 or greater. An area ratio of the second grains relative to the total dielectric grain area in the capacitance‑forming portion is between 0.07 and 0.99.

### CROSS-REFERENCE TO RELATED APPLICATIONS

This application claims benefit of priority to Korean Patent Application No. 10-2025-0039503 filed on Mar. 27, 2025 in the Korean Intellectual Property Office, the disclosure of which is incorporated herein by reference in its entirety.

### TECHNICAL FIELD

The present disclosure relates to a multilayer electronic component.

Multilayer ceramic capacitors (MLCCs), a widely used class of multilayer electronic components, are chip‑shaped capacitors mounted on printed circuit boards in a broad range of electronic devices. Such devices include video display products such as Liquid Crystal Displays (LCDs) and Plasma Display Panels (PDPs), as well as computers, smartphones, and various mobile communication devices, in which MLCCs perform repeated charging and discharging functions essential to circuit stability.

MLCCs typically include a dielectric layer, internal electrodes, and external electrodes, and the capacitance per unit volume is determined primarily by the dielectric properties of the dielectric layer. These dielectric properties depend on several microstructural factors, including the dielectric layer thickness, the composition of the dielectric material, and the size and morphology of the dielectric crystal grains.

Historically, attempts to increase capacitance have focused on reducing the thickness of the dielectric layer or controlling the grain size through sintering and additive selection. However, further reductions in dielectric layer thickness are increasingly limited by the ongoing miniaturization of MLCCs, which creates reliability concerns and processing challenges. Likewise, efforts to tune dielectric composition have encountered constraints in the number and types of additives or dopants that can be introduced without degrading dielectric performance or causing compositional non‑uniformity within different regions of the device. As a result, conventional approaches, whether based on thickness reduction, grain size adjustment, or compositional modification, have reached practical limits. Thus, there is a need for new and improved methods for developing dielectric properties through more advanced microstructural control.

### SUMMARY

An aspect of the present disclosure is to improve capacitance per unit volume of a multilayer electronic component through a dielectric layer having improved dielectric constant.

According to an aspect of the present disclosure, a multilayer electronic component includes a body including a dielectric layer containing dielectric grains, an internal electrode, and a capacitance-forming portion in which the dielectric layer and the internal electrode are stacked to form capacitance; and an external electrode disposed on the body and connected to the internal electrode. The dielectric grains include first grains having an aspect ratio of less than 1:5 and second grains having an aspect ratio of 1:5 or more, and an area ratio of the second grains of the dielectric grains per unit area in the capacitance-forming portion is 0.07 or more and 0.99 or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment;

FIG. 2 schematically illustrates an exploded perspective view of a body according to an embodiment;

FIG. 3 schematically illustrates a cross-sectional view taken along line I-I’ of FIG. 1;

FIG. 4 schematically illustrates a cross-sectional view taken along line II-II’ of FIG. 1;

FIG. 5 is an enlarged schematic view of area P0 of FIG. 3;

FIG. 6 is an enlarged schematic view of area P1 of FIG. 3;

FIG. 7 is an enlarged schematic view of area P2 of FIG. 3;

FIG. 8 is a schematic view of a first crystal grain according to an embodiment;

FIG. 9 is a schematic view of a second crystal grain according to an embodiment; and

FIG. 10 is an enlarged schematic view of area Q of FIG. 7.

### DETAILED DESCRIPTION

Hereinafter, embodiments will be described with reference to detailed embodiments and the attached drawings. However, the embodiments may be modified in various other forms, and the scope of the present disclosure is not limited to the embodiments described below. Furthermore, the embodiments are provided to more fully explain the present disclosure to those skilled in the art. Therefore, the shapes and sizes of elements in the drawings may be exaggerated for clarity, and elements indicated by the same reference numerals in the drawings are identical elements.

In addition, to clearly describe the present disclosure, parts irrelevant to the description are omitted. The size and thickness of each component shown in the drawings are arbitrarily indicated for convenience of explanation. Therefore, the present disclosure is not necessarily limited to that shown. Furthermore, components with identical functions within the scope of the same concept are described using the same reference numerals. Furthermore, throughout the specification, when a part is referred to as “including” a component, this does not exclude other components, but rather implies the inclusion of other components, unless otherwise stated.

In the drawings, the x-direction may refer to the thickness direction, the y-direction may refer to the length direction, and the z-direction may refer to the width direction. The stacking direction of the internal electrodes 121 and 122 and the dielectric layer 111 may be the thickness direction or the width direction.

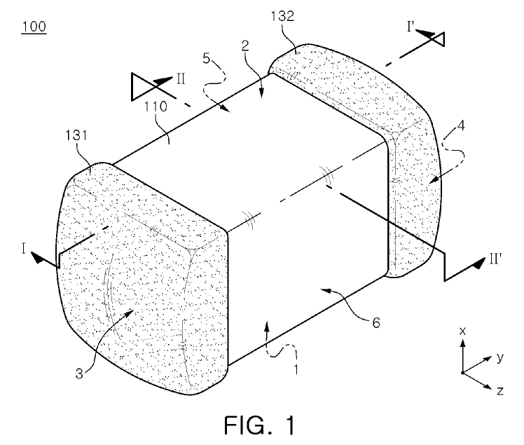

FIG. 1 is a schematic perspective view of a multilayer electronic component according to an embodiment.

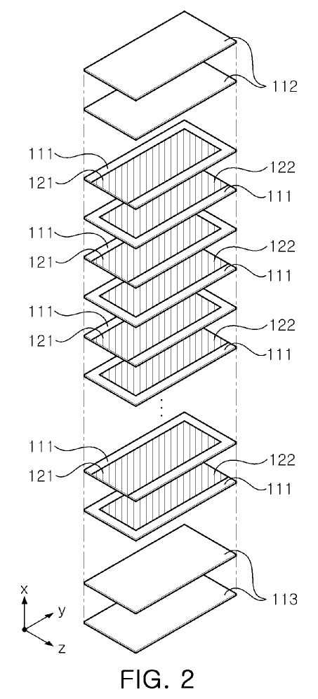

FIG. 2 is a schematic exploded perspective view of a body according to an embodiment.

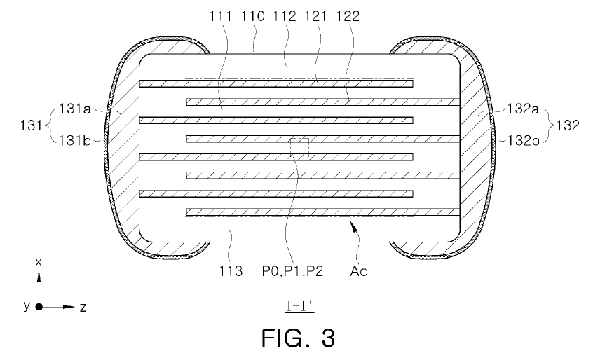

FIG. 3 schematically illustrates a cross-sectional view taken along line I-I’ of FIG. 1.

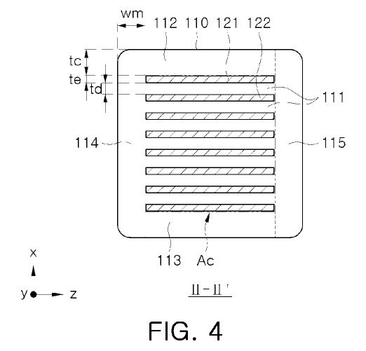

FIG. 4 schematically illustrates a cross-sectional view taken along line II-II’ of FIG. 1.

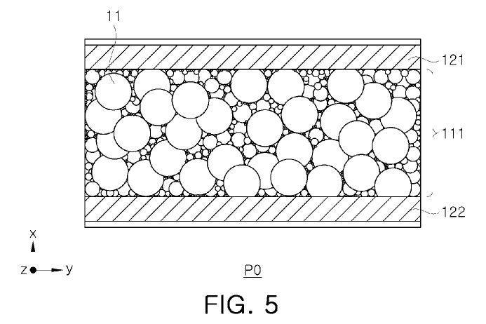

FIG. 5 is an enlarged schematic view of area P0 of FIG. 3.

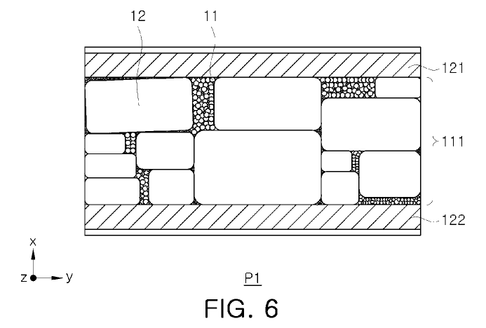

FIG. 6 is an enlarged schematic view of area P1 of FIG. 3.

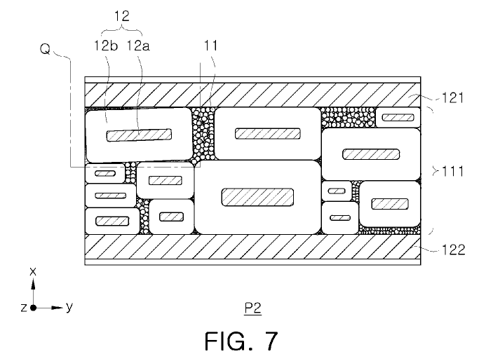

FIG. 7 is an enlarged schematic view of area P2 of FIG. 3.

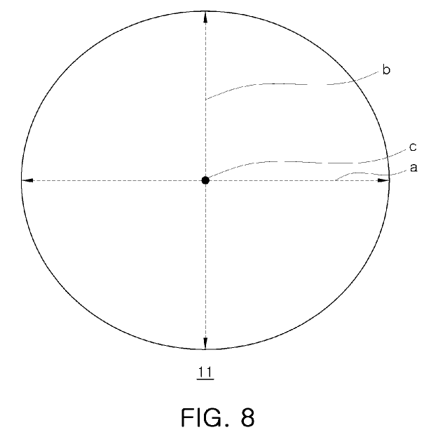

FIG. 8 is a schematic view of a first crystal grain according to an embodiment.

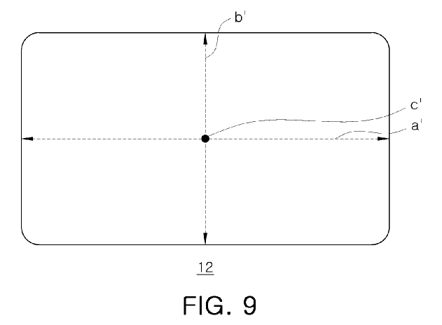

FIG. 9 is a schematic view of a second crystal grain according to an embodiment.

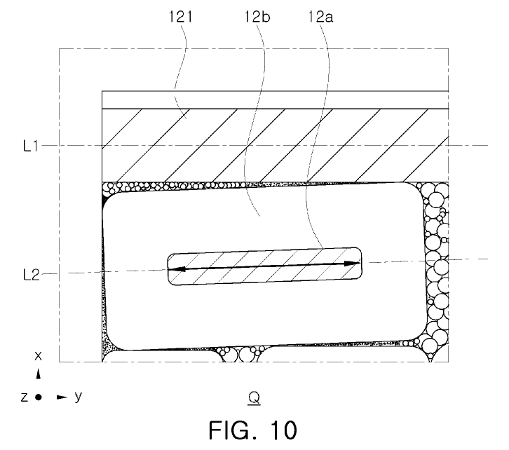

FIG. 10 is an enlarged schematic view of area Q of FIG. 7.

Hereinafter, with reference to FIGS. 1, 2, 3, 4, 5, 6, 7, 8, 9 and 10, a multilayer electronic component 100 according to an embodiment and various embodiments thereof will be described in detail. 23

The multilayer electronic component 100 according to an embodiment may include a body 110 including a dielectric layer 111 including dielectric grains 11 and 12, internal electrodes 121 and 122, and a capacitance-forming portion Ac in which the dielectric layer 111 and the internal electrodes 121 and 122 are stacked to form capacitance, and external electrodes 131 and 132 disposed on the body 110 and connected to the internal electrodes 121 and 122. The dielectric grains 11 and 12 may include first grains 11 having an aspect ratio of less than 1:5 and second grains 12 having an aspect ratio of 1:5 or more, and the ratio of the area of the second grains 12 per unit area of the dielectric grains 11 and 12 in the capacitance-forming portion Ac may be 0.07 or more and 0.99 or less.

The body 110 may include a dielectric layer 111 including dielectric grains 11 and 12, internal electrodes 121 and 122, and a capacitance-forming portion Ac in which the dielectric layer 111 and the internal electrodes 121 and 122 are stacked to form capacitance.

The body 110 may have the dielectric layer 111 and the internal electrodes 121 and 122 alternately stacked.

The capacitance-forming portion Ac may be a region in which capacitance is formed by including a first internal electrode 121 and a second internal electrode 122 that are alternately disposed to face each other with the dielectric layer 111 interposed therebetween.

While there are no particular limitations on the detailed shape of the body 110, as illustrated, the body 110 may be formed in a hexahedral shape or a similar shape. Due to the shrinkage of the ceramic particles contained in the body 110 during the firing process, the body 110 may not have a perfectly straight hexahedral shape, but may have a substantially hexahedral shape.

Referring to FIG. 1, the body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3 and 4 and opposing each other in a third direction.

The plurality of dielectric layers 111 forming the body 110 may be in a fired state, and the boundaries between adjacent dielectric layers 111 may be integrated to a degree that is difficult to confirm without using a scanning electron microscope (SEM).

The raw material forming the dielectric layer 111 is not limited as long as it may obtain sufficient capacitance. Typically, perovskite (ABO₃) materials may be used.

The dielectric layer 111 may be formed using a dielectric material such as barium titanate (BaTiO₃), and thus may include a dielectric microstructure after firing. The dielectric microstructure may include a plurality of dielectric grains 11 and 12, dielectric grain boundaries disposed between adjacent dielectric grains 10, and dielectric triple points disposed at points where three or more dielectric grain boundaries contact each other, and may include a plurality of each thereof.

Referring to FIG. 6, the dielectric grains 11 and 12 included in the dielectric layer 111 may be divided into first grains 11 and second grains 12 based on aspect ratios thereof. In detail, the dielectric grains 11 and 12 may include a first grain 11 having an aspect ratio of less than 1:5 and a second grain 12 having an aspect ratio of 1:5 or more. In this case, an aspect ratio of less than 1:5 for the first grain 11 may indicate that the crystal growth of the first grain 11 did not occur in a specific direction, and an aspect ratio of 1:5 or more for the second grain 12 may indicate that the crystal growth of the second grain occurred in a specific direction (major axis direction).

Referring to FIG. 5, a dielectric layer 111 of a typical multilayer electronic component of the related art may be composed of first grains 11 having an aspect ratio of less than 1:5, and the crystal growth direction of these first grains 11 may be uncontrolled.

On the other hand, referring to FIG. 6, the dielectric layer 111 of the multilayer electronic component 100 according to an embodiment of the present disclosure may include second crystal grains 12 in which crystal growth is formed in a specific direction (major axis direction) with an aspect ratio of 1:5 or more. In this way, when the second crystal grains 12 in which crystal growth is formed in a specific direction (major axis direction) are included in the dielectric layer 111, the dielectric constant of the dielectric layer 111 is improved, and as a result, the capacitance per unit volume of the multilayer electronic component 100 may be improved.

Meanwhile, in the capacitance-forming portion Ac, if the area ratio of the second grains 12 to the total area of the dielectric grains 11 and 12 is less than 0.07, the dielectric layer 111 exhibits insufficient dielectric constant enhancement compared to the case of the related art where the dielectric layer 111 is composed of the first grains 11. Consequently, the capacitance enhancement per unit volume of the multilayer electronic component 100 may also be so insignificant that it cannot be measured. Therefore, in an embodiment of the present disclosure, by adjusting the area ratio of the second grains 12 to the total area of the dielectric grains 11 and 12 in the capacitance-forming portion Ac to 0.07 or more, the dielectric constant of the dielectric layer 111 may be improved by three times or more compared to the case of the related art. Consequently, the capacitance per unit volume of the multilayer electronic component 100 may also be sufficiently improved.

Meanwhile, in the capacitance-forming portion Ac, when the area ratio of the second crystal grains 12 per unit area of the dielectric crystal grains 11 and 12 is 0.50 or more, the improvement in capacitance per unit volume of the multilayer electronic component 100 in the present disclosure may be more significant. For example, in an embodiment, the area ratio of the second crystal grains 12 per unit area of the dielectric crystal grains 11 and 12 in the capacitance-forming portion Ac may be 0.50 or more and 0.99 or less.

In the capacitance-forming portion Ac, the area ratio of the second crystal grains 12 per unit area of the dielectric crystal grains 11 and 12 may be measured by observing images of a 5 µm X 5 µm area in the center portion of the capacitance-forming portion Ac of the first and second-direction cross section polished up to the third-direction 1/2 point of the multilayer electronic component 100, two or more 5 µm X 5 µm areas located at equal intervals in the first-direction upper and lower portions with respect to the center portion, and two or more 5 µm X 5 µm areas located at equal intervals in the second-direction left and right with respect to the center portion, using a Scanning Electron Microscope (SEM) or the like, processing the images with an image processing program to distinguish between crystal grains and crystal grain boundaries, and then calculating the area of each crystal grain.

In detail, after forming major axes a and a’ and minor axes b and b’ passing through the centers of respective dielectric grains 11 and 12, the length of the minor axis: the length of the major axis is calculated as the aspect ratio. A grain having an aspect ratio of less than 1:5 may be classified as a first grain 11, and a grain having an aspect ratio of 1:5 or more may be classified as a second grain 12. Meanwhile, referring to FIG. 8 and FIG. 9, the center of the first grain 11 may be expressed as c, the major axis passing through the center c may be expressed as a, and the minor axis passing through the center c may be expressed as b, and the center of the second grain 12 may be expressed as c’, the major axis passing through the center c’ may be expressed as a’, and the minor axis passing through the center c’ may be expressed as b’.

Meanwhile, the centers of respective dielectric grains 11 and 12 may refer to the centers of the major axes a and a’ of respective grains, and the minor axes b and b’ may refer to line segments passing through the centers of the major axes a and a’ and being perpendicular to the major axes a and a’.

After the first grain 11 and the second grain 12 are distinguished according to the aspect ratios thereof, the first grain 11 and the second grain 12 may be visually distinguished by differences in brightness or color, and the respective areas of the first grain 11 and the second grain 12 may be calculated. Based thereon, the area ratio of the second grain 12 to the total area of the first grain 11 and the second grain 12 may be calculated as the area ratio of the second grain 12 per unit area of the dielectric grains 11 and 12 in each region. Then, after repeating these measurements in respective regions and taking the average value, the area ratio of the second grains 12 to the total area of the dielectric grains 11 and 12 in the capacitance-forming portion Ac may be measured.

In the capacitance-forming portion Ac, the upper limit of the area ratio of the second grains 12 to the total area of the dielectric grains 11 and 12 is not particularly limited. However, if the first grains 11 are substantially not formed when the dielectric grains 11 and 12 are formed, the dielectric constant of the dielectric layer 111 may be significantly improved. In this case, the area ratio of the second grains 12 to the total area of the dielectric grains 11 and 12 may be 0.99 or less.

The method for controlling the aspect ratio of the second grains 12 is not particularly limited. For example, the aspect ratio of the second crystal grain 12 may be controlled by being oriented by a plate-shaped single crystal included in the dielectric sheet for forming the dielectric layer 111.

In detail, the pre-synthesized plate-shaped single crystal is added to the raw material slurry during the dielectric sheet forming process, and during the dielectric sheet forming process, may be aligned horizontally with the dielectric sheet by the shear stress when passing through the gap after extrusion during the formation process of the dielectric sheet. During the sintering process, the dielectric grains included in the dielectric sheet may grow in the same direction as the aligned plate-shaped single crystal. Meanwhile, the first crystal grains are not oriented by the plate-shaped single crystal, and the crystal growth direction thereof may be determined randomly. Accordingly, the dielectric grains 11 and 12 in the present disclosure may have a degree of orientation of at least a predetermined threshold for a specific crystal plane. The degree of orientation of the dielectric grains 11 and 12 with respect to a specific crystal plane may increase or decrease in proportion to the area fraction of the second grain 12 whose crystal growth direction is controlled along a specific direction.

Meanwhile, the main components of the plate-shaped single crystal grains may be BaTiO₃, K_{0.5}Na_{0.5}NbO₃, Bi₄Ti₃O₁₂, Bi_{0.5}Na_{0.5}TiO₃, Na_{0.5}Bi_{4.5}Ti₄O₁₅, Pb(Zr,Ti)O₃ , and the like. The plate-shaped single crystals may be synthesized using the molten salt method, but the present disclosure is not limited thereto.

As in an embodiment, when the area ratio of the second grain 12 per unit area of the dielectric grains 11 and 12 is 0.07 or more and 0.99 or less, the dielectric grains 11 and 12 may be oriented with respect to a specific crystal plane.

The fact that the dielectric grains 11 and 12 are “oriented” with respect to a specific crystal plane may mean that “the crystal growth of the dielectric grains 11 and 12 occurs in the direction of a specific crystal plane.” In this case, the specific crystal plane may refer to one or more of the (00l) plane, the (0l0) plane, the (l00) plane, and the (lll) plane of the dielectric crystal structure.

Meanwhile, in an embodiment, the degree of orientation of the dielectric grains 11 and 12 with respect to a specific crystal plane may be 30% or more, thereby further improving the dielectric properties of the dielectric layer 111. The upper limit of the degree of orientation of the dielectric grains 11 and 12 with respect to a specific crystal plane is not particularly limited. For example, the degree of orientation of the dielectric grains 11 and 12 with respect to a specific crystal plane may be 99% or less.

The degree of orientation of the dielectric grains 11 and 12 for a specific crystal plane may be measured by performing X-ray diffraction (XRD) analysis on the dielectric layer of the capacitance-forming portion Ac in the first and second-direction cross-section of the multilayer electronic component 100 polished up to a 1/2 point in the third direction. In detail, the XRD analysis may be performed at a scan speed of 1 degree/min within a 2θ range of 20 degrees or more and 80 degrees or less, and the percentage of the sum of the peak areas of the specific crystal plane relative to the total peak area may be measured.

The degree of orientation of the dielectric grains 11 and 12 for a specific crystal plane may also be measured by performing Electron Backscatter Diffraction (EBSD) analysis on the dielectric layer of the capacitance-forming portion Ac in the first and second-direction cross-section of the multilayer electronic component 100 polished up to a 1/2 point in the third direction. Therefore, the crystal orientation and phase of each grain may be specified, and may be measured by calculating the ratio of the parallelism between a specific crystal plane and the growth direction (major axis) of the grain.

In an embodiment, the first grain 11 may contain BaTiO₃ as its main component. However, the type of dielectric material contained in the first grain 11 is not limited thereto, and the first grain 11 may include, as the main component thereof, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium (Ca), zirconium (Zr), or the like is partially solubilized in BaTiO₃.

Meanwhile, the first crystal grain 11 may further include at least one of Li, Al, Cu, Dy, Y, Tb, and Si, as additives or doping elements, in addition to the main components, Ca and Zr, thereby enhance the reliability of the dielectric layer.

Referring to FIG. 7, in an embodiment, the second crystal grain 12 may include a core 12a with an aspect ratio of 1:5 or more, and a shell 12b disposed on the core 12a. When the second crystal grain 12 includes the core 12a with an aspect ratio of 1:5 or more, the degree to which the second crystal grain 12, including the shell 12b, grows along a specific direction may be enhanced. Consequently, the dielectric constant of the dielectric layer 111 may be further enhanced. Meanwhile, if the aspect ratio of the core 12a is less than 1:5, the degree to which the second crystal grains 12, including the shell 12b, grow along a specific direction may be weakened, thereby reducing the dielectric constant enhancement effect of the dielectric layer 111 in the present disclosure.

In an embodiment, the core 12a of the second crystal grains 12 may be formed of a single crystal. In this case, the aspect ratio is 1:5 or more, and the growth of the dielectric grains in a specific direction centered around the core 12a formed of a single crystal may be further promoted, thereby further enhancing the dielectric constant of the dielectric layer 111.

In an embodiment, the dielectric layer 111 may include dielectric grains 11 and 12, and the dielectric grains 11 and 12 may include a second grain 12 including a core 12a formed of a single crystal and a shell 12b disposed on the core 12a, and a first grain 11 not including the core 12a. At this time, the crystal growth direction of the shell 12b of the second grain 12 may be substantially the same as the crystal growth direction of the core 12a. Meanwhile, the meaning that the crystal growth direction of the shell 12b and the crystal growth direction of the core 12a are “substantially the same” may mean that when the dielectric layer included in the capacitance-forming portion Ac is converted into an Inverse Pole FIGURE(IPF) map through Electron Backscatter Diffraction (EBSD) analysis, the color codes have a consistency of 95% or more, and in more detail. In more detail, when Electron Backscatter Diffraction (EBSD) analysis is performed on a 5 µm X 5 µm area at the center of the capacitance-forming portion Ac in the first and second direction cross-section provided by polishing up to the third-direction 1/2 point of the multilayer electronic component 100, and is converted into an Inverse Pole FIGURE(IPF) map image; it may mean that the color codes have a consistency of 95% or more. At this time, a color code consistency of 95% or more may indicate that the tolerance angle is 10 degrees or less in the target determination direction during Orientation Imaging Microscopy (OIM) analysis.

In the core(12a)-shell(12b) structure of the second crystal grain 12, the core 12a may include one of BaTiO₃, K_{0.5}Na_{0.5}NbO₃, Bi₄Ti₃O₁₂, Bi_{0.5}Na_{0.5}TiO₃, Na_{0.5}Bi_{4.5}Ti₄O₁₅, and Pb(Zr,Ti)O₃ as a main component. In this case, including a specific component as a main component may mean including 50 moles or more of the specific component out of 100 moles of the total components. Materials such as BaTiO₃, K_{0.5}Na_{0.5}NbO₃, Bi₄Ti₃O₁₂, Bi_{0.5}Na_{0.5}TiO₃, Na_{0.5}Bi_{4.5}Ti₄O₁₅, and Pb(Zr,Ti)O₃ may have high dielectric constant and properties that facilitate the formation of single crystals.

In an embodiment, the core 12a may further include at least one element among Li, Ca, Al, Cu, Zr, Dy, Y, Tb, and Si, as additives or doping elements, in addition to the main component.

Meanwhile, if the core 12a is formed of a single crystal, the additive elements and doping elements included in the additives used as raw materials for forming the dielectric layer 111 may not be substantially contained in the core 12a but may be contained only in the shell 12b. For example, the amount of at least one element among Li, Ca, Al, Cu, Zr, Dy, Y, Tb, and Si that may be contained in the core 12a may be 0.5 moles or less relative to 100 moles of the main component.

Meanwhile, according to an embodiment, the core 12a may not be contained in the first crystal grain 11. For example, the core 12a may be disposed outside the first crystal grain 11 or disposed away from the first crystal grain 11.

In an embodiment, the core 12a may have an aspect ratio of 1:5 or more, and the average length of the major axis of the core 12a may be 0.05 µm or more and 5 µm or less. The major axis of the core 12a may be the major axis passing through the center of the core 12a, and the average length of the major axis may refer to the average value of the length of the major axis of the core 12a measured by processing images, observed by a Scanning Electron Microscope (SEM) or the like, of a 5 µm X 5 µm area in the center of the capacitance-forming portion Ac of the first and second-direction cross section polished to the third-direction 1/2 point of the multilayer electronic component 100, two or more 5 µm X 5 µm areas located at equal intervals in the first-direction upper and lower portions with respect to the center, and two or more 5 µm X 5 µm areas located at equal intervals in the second-direction left and right with respect to the center, using an image processing program.

Meanwhile, the core 12a and shell 12b may be distinguished by composition. In detail, the region where the content of at least one of Li, Ca, Al, Cu, Zr, Dy, Y, Tb, and Si, as measured by SEM-EDX or TEM-EDX line profile analysis, begins to decrease to 0.5 mol or less relative to 100 mol of the main component, may be designated as the core 12a, and the remaining region may be designated as the shell 12b.

In an embodiment, the average angle between the internal electrode 121 and the core 12a may be 80 degrees or more and 100 degrees or less, thereby further enhancing the tendency for the second crystal grains 12 to grow along a specific direction, and also further enhancing the capacitance per unit volume of the multilayer electronic component 100 due to the enhanced dielectric constant of the dielectric layer 111.

Referring to FIG. 10, the angle formed by the internal electrode 121 and the core 12a may be expressed as the angle formed by lines L1 and L2. Line L1 is a straight line connecting points that divide the area where the internal electrode and the body come into contact, into two equal parts in the first direction, and L2 may be a straight line extending along the major axis of the core 12a. The angle between L1 and L2 may be measured as an average value for a plurality of cores 12a observed by a scanning electron microscope (SEM) in an area of 5 µm X 5 µm in size including an internal electrode located at the center of the capacitance-forming portion Ac in the first and second-direction cross-sections polished to the third-direction 1/2 point of the multilayer electronic component 100 and a dielectric layer disposed between these internal electrodes. The angle formed by the internal electrode 121 and the core 12a may be further generalized by repeatedly measuring this average value in two or more 5 µm X 5 µm areas located at the upper and lower portions in the first direction with equal intervals in the first direction based on the center of the capacitance-forming portion Ac, and in two or more 5 µm X 5 µm areas located on the left and right in the second direction with equal intervals in the second direction based on the center, and taking the average value thereof. Meanwhile, the size of the observation area may vary depending on the thickness of the dielectric layer.

The thickness td of the dielectric layer 111 need not be specifically limited.

However, to facilitate miniaturization and high-capacitance multilayer electronic component 100, the thickness of the dielectric layer 111 may be 0.6 μm or less, in more detail, 0.4 μm or less.

In this case, the thickness td of the dielectric layer 111 may refer to the thickness td of the dielectric layer 111 disposed between the first and second internal electrodes 121 and 122.

Meanwhile, the thickness td of the dielectric layer 111 may refer to the first direction size of the dielectric layer 111. Furthermore, the thickness td of the dielectric layer 111 may refer to the average thickness td of the dielectric layer 111 in the first direction, or the average thickness td of the dielectric layer 111 in the first direction.

The first-direction average size of the dielectric layer 111 may be measured by scanning the first and second-direction cross-section of the body 110 using a scanning electron microscope (SEM) at 10,000x magnification. In more detail, the first-direction average size of a single dielectric layer 111 may be calculated as an average value by measuring the first-direction size at five or more equally spaced points in the second direction of the scanned image. The five or more equally spaced points may be designated as the capacitance-forming portion Ac. Furthermore, by extending this average value measurement to five or more dielectric layers 111 and measuring the average value, the first-direction average size of the dielectric layer 111 may be further generalized.

Referring to FIG. 2, internal electrodes 121 and 122 may be alternately stacked with the dielectric layer 111.

The internal electrodes 121 and 122 may include a first internal electrode 121 and a second internal electrode 122. The first and second internal electrodes 121 and 122 may be alternately disposed with the dielectric layer 111 interposed therebetween that constitutes the body 110, to face each other, and may be exposed through the third and fourth surfaces 3 and 4 of the body 110, respectively.

In more detail, the first internal electrode 121 may be spaced apart from the fourth surface 4 and exposed through the third surface 3, and the second internal electrode 122 may be spaced apart from the third surface 3 and exposed through the fourth surface 4. On the third surface 3 of the body 110, a first external electrode 131 may be disposed and connected to the first internal electrode 121, and on the fourth surface 4 of the body 110, a second external electrode 132 may be disposed and connected to the second internal electrode 122.

For example, referring to FIG. 3, the first internal electrode 121 may be connected to the first external electrode 131 without being connected to the second external electrode 132, and the second internal electrode 122 may be connected to the second external electrode 132 without being connected to the first external electrode 131. At this time, the first and second internal electrodes 121 and 122 may be electrically isolated from each other by the dielectric layer 111 disposed therebetween.

Meanwhile, the body 110 may be formed by alternately stacking ceramic green sheets printed with a first internal electrode 121 and ceramic green sheets printed with a second internal electrode 122, followed by firing.

The material forming the internal electrodes 121 and 122 is not particularly limited, and any material with excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for the internal electrode containing at least one of nickel (Ni), copper (Cu), palladium (Pd), silver (Ag), gold (Au), platinum (Pt), tin (Sn), tungsten (W), titanium (Ti) and alloys thereof on a ceramic green sheet. The printing method of the conductive paste for the internal electrode may use a screen printing method or a gravure printing method, but the present disclosure is not limited thereto.

Meanwhile, the thickness te of the internal electrodes 121 and 122 need not be specifically limited.

However, to facilitate miniaturization and higher capacitance of multilayer electronic components, the thickness of the internal electrodes 121 and 122 may be 0.6 μm or less, in more detail, 0.4 μm or less.

In this case, the thickness te of the internal electrodes 121 and 122 may refer to the size of the internal electrodes 121 and 122 in the first direction. Furthermore, the thickness te of the internal electrodes 121 and 122 may refer to the average thickness te of the internal electrodes 121 and 122 and may refer to the average size of the internal electrodes 121 and 122 in the first direction.

The first-direction average size of the internal electrodes 121 and 122 may be measured by scanning the first and second-direction cross-section of the body 110 using a scanning electron microscope (SEM) at 10,000x magnification. In more detail, the first-direction average size of one internal electrode may be an average value calculated by measuring the first-direction size of one internal electrode at five or more equally spaced points in the second direction in the scanned image. The five or more equally spaced points may be designated in the capacitance-forming portion Ac. Furthermore, by extending this average value measurement to five or more internal electrodes 121 and 122 and measuring the average value, the first-direction average size of the internal electrodes 121 and 122 may be further generalized.

Meanwhile, referring to FIG. 3, the body 110 may include cover portions 112, 113 disposed on both end surfaces of the capacitance-forming portion Ac in the first direction.

In detail, the body 110 may include a first cover portion 112 disposed on one surface of the capacitance-forming portion Ac in the first direction and a second cover portion 113 disposed on the other surface of the capacitance-forming portion Ac in the first direction. In more detail, the body 110 may include an upper cover portion 112 disposed above the capacitance-forming portion Ac in the first direction and a lower cover portion 113 disposed below the capacitance-forming portion Ac in the first direction.

The upper cover portion 112 and lower cover portion 113 may be formed by stacking a single dielectric layer 111 or two or more dielectric layers 111 on the upper and lower surfaces of the capacitance-forming portion Ac in a first direction, respectively. They may fundamentally prevent damage to the internal electrodes 121 and 122 due to physical or chemical stress.

The upper cover portion 112 and lower cover portion 113 do not include the internal electrodes 121 and 122 and may contain the same material as the dielectric layer 111. For example, the upper cover portion 112 and lower cover portion 113 may contain a ceramic material, for example, a barium titanate (BaTiO₃)-based ceramic material.

Meanwhile, the thickness tc of the cover portions 112, 113 need not be specifically limited.

However, to more easily obtain miniaturization and high capacitance of multilayer electronic components, the thickness tc of the cover portions 112 and 113 may be 100 μm or less, in detail, 30 μm or less, and in more detail, 20 μm or less for ultra-small products.

In this case, the thickness tc of the cover portions 112 and 113 may refer to the size of the cover portions 112 and 113 in the first direction. Furthermore, the thickness tc of the cover portions 112 and 113 may refer to the average thickness tc of the cover portions 112 and 113 and may refer to the average size of the cover portions 112 and 113 in the first direction.

The first-direction average size of the cover portions 112 and 113 may be measured by scanning the first and second cross-sections of the body 110 using a scanning electron microscope (SEM) at 10,000x magnification. In more detail, the first-direction average size may be calculated by measuring the first-direction size at 30 equally spaced points in the second direction in a scanned image of one cover portion.

Furthermore, the first-direction average size of the cover portion measured using the aforementioned method may be substantially the same size as the first-direction average size of the cover portion in the first and third-direction cross-section of the body 110.

Meanwhile, referring to FIG. 4, margin portions 114 and 115 may be disposed on both end surfaces of the body 110 in the third direction.

In more detail, the margin portions 114 and 115 may include a first margin portion 114 disposed on the fifth surface 5 of the body 110 and a second margin portion 115 disposed on the sixth surface 6. In detail, the margin portions 114 and 115 may be disposed on both end surfaces of the body 110 in the third direction.

As illustrated, the margin portions 114 and 115 may refer to the area between the third-direction end surfaces of the first and second internal electrodes 121 and 122 and the boundary surface of the body 110, based on the first and third-direction cross-section of the body 110.

The margin portions 114 and 115 may fundamentally serve to prevent damage to the internal electrodes 121 and 122 due to physical or chemical stress.

The margin portions 114 and 115 may be formed by applying conductive paste to the ceramic green sheet, except for the areas where the margin portions 114 and 115 will be formed, to form the internal electrodes 121 and 122. To suppress the step difference caused by the internal electrodes 121 and 122, the internal electrodes 121 and 122 are cut so that they are exposed to the fifth and sixth surfaces 5 and 6 of the body 110. Then, a single dielectric layer 111 or two or more dielectric layers 111 may be formed by stacking the dielectric layers in a third direction on both end surfaces of the capacitance-forming portion Ac.

The first margin portion 114 and the second margin portion 115 do not include internal electrodes 121 and 122 and may contain the same material as the dielectric layer 111. For example, the first margin portion 114 and the second margin portion 115 may contain a ceramic material, for example, a barium titanate (BaTiO₃)-based ceramic material.

Meanwhile, the width wm of the first and second margin portions 114 and 115 need not be specifically limited.

However, to facilitate miniaturization and high capacitance of the multilayer electronic component 100, the width wm of the first and second margin portions 114 and 115 may be 100 μm or less, in detail, 30 μm or less, and in more detail, 20 μm or less for ultra-small products.

In this case, the width wm of the margin portions 114 and 115 may refer to the third-direction size of each of the margin portions 114 and 115. Furthermore, the width wm of the margin portions 114 and 115 may refer to the average width wm of the margin portions 114 and 115, and may refer to the third-direction average size of the margin portions 114 and 115.

The third-direction average size of the margin portions 114 and 115 may be measured by scanning images of the first and third-direction cross-section of the body 110 using a scanning electron microscope (SEM) at 10,000x magnification. In more detail, the third-direction average size may refer to an average value calculated by measuring the third-direction size at 10 equally spaced points in the first direction in a scanned image of one margin portion.

In an embodiment, a ceramic electronic component 100 is described as having a structure having two external electrodes 131 and 132, but the number or shape of the external electrodes 131 and 132 may be changed depending on the shape of the internal electrodes 121 and 122 or other purposes.

Referring to FIG. 1, external electrodes 131 and 132 may be disposed on the body 110.

The external electrodes 131 and 132 may be disposed on the body 110 and connected to internal electrodes 121 and 122.

In more detail, the external electrodes 131 and 132 may be disposed on the third and fourth surfaces 3 and 4 of the body 110, respectively, and may include first and second external electrodes 131 and 132 connected to the first and second internal electrodes 121 and 122, respectively. In detail, the first external electrode 131 may be disposed on the third surface 3 of the body and connected to the first internal electrode 121, while the second external electrode 132 may be disposed on the fourth surface 4 of the body and connected to the second internal electrode 122.

Additionally, the external electrodes 131 and 132 may be disposed by extending to portions of the first and second surfaces 1 and 2 of the body 110, or may be disposed by extending to portions of the fifth and sixth surfaces 5 and 6 of the body 110. For example, the first external electrode 131 may be disposed on portions of the first, second, fifth, and sixth surfaces 1, 2, 5 and 6 of the body 110, and on the third surface 3 of the body 110, and the second external electrode 132 may be disposed on portions of the first, second, fifth, and sixth surfaces 1, 2, 5 and 6 of the body 110, and on the third surface 3 of the body 110.

The external electrodes 131 and 132 may be formed using any material that is electrically conductive, such as metal. The specific material may be determined based on electrical properties, structural stability, and other factors. Furthermore, the external electrodes 131 and 132 may have a multilayer structure.

For example, the external electrodes 131 and 132 may include electrode layers 131a and 132a disposed on the body 110 and plating layers 131b and 132b disposed on the electrode layers 131a and 132a.

In more detail, the electrode layers 131a and 132a may be sintered electrodes including a conductive metal and glass, or resin-based electrodes including a conductive metal and resin.

Furthermore, the electrode layers 131a and 132a may be formed by sequentially forming sintered electrodes and resin-based electrodes on the body 110.

In addition, the electrode layers 131a and 132a may be formed by transferring a sheet containing a conductive metal onto the body 110, or by transferring a sheet containing a conductive metal onto a sintered electrode.

The conductive metal used in the electrode layers 131a and 132a is not particularly limited as long as it may be electrically connected to the internal electrodes 121 and 122 to form capacitance. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof. The electrode layers 131a and 132a may be formed by applying a conductive paste prepared by adding glass frit to the conductive metal particles, followed by firing.

The plating layers 131b and 132b may improve mounting characteristics.

The type of the plating layers 131b and 132b is not particularly limited. The plating layers 131b and 132b may be plating layers 131b and 132b of a single layer containing at least one of nickel (Ni), tin (Sn), silver (Ag), palladium (Pd), and alloys thereof, or may be formed as a plurality of layers.

In more detailed examples of the plating layers 131b and 132b, the plating layers 131b and 132b may be a nickel (Ni) plating layer or a tin (Sn) plating layer. The plating layers 131b and 132b may be in the form in which the nickel plating layer and the tin plating layer are sequentially formed on the electrode layers 131a and 132a, or in the form in which a tin plating layer, a nickel plating layer, and a tin plating layer are sequentially formed. Additionally, the plating layers 131b and 132b may include a plurality of Ni plating layers and/or a plurality of Sn plating layers.

The size of the multilayer electronic component 100 does not need to be specifically limited.

However, to obtain both miniaturization and high capacitance, the thickness of the dielectric layer and internal electrode should be reduced and the number of layers thereof should be increased. Therefore, the effects of the present disclosure may be more pronounced in multilayer electronic components 100 of sizes equal to or smaller than 1005 (length × width: 1.0 mm × 0.5 mm, length and width tolerance range within ±5%) size and 0603 (length × width: 0.6 mm × 0.3 mm, length and width tolerance range within ±5%) size.

As set forth above, according to an embodiment, a dielectric constant of a dielectric layer may be improved by aligning a growth direction of dielectric grains included in the dielectric layer, and further, capacitance per unit volume of a multilayer electronic component may be improved.

Further, according to an embodiment, a dielectric constant of a dielectric layer may be improved by controlling the degree of orientation of dielectric grains within the dielectric layer with respect to a specific plane, thereby enhancing the capacitance per unit volume of a multilayer electronic component.

While embodiments have been described in detail above, the present disclosure is not limited to the above-described embodiments and the attached drawings, but is intended to be defined by the appended claims. Therefore, those skilled in the art will appreciate that various substitutions, modifications, and alterations may be made without departing from the technical spirit of the present disclosure as defined in the claims, and such modifications are also within the scope of the present disclosure.

Furthermore, the term “an embodiment” used herein does not imply identical embodiments, and rather, is provided to emphasize and explain the unique features of each embodiment. However, the presented embodiments do not preclude implementation in combination with features of other embodiments. For example, even if a description in a specific embodiment is not described in another embodiment, it can be understood as relating to the other embodiment, unless otherwise described in the other embodiment, which is contrary to or contradicts the description.

The terminology used in this specification is solely for describing an embodiment and is not intended to limit the present disclosure. In this case, singular expressions include plural expressions unless the context clearly indicates otherwise.

While example embodiments have been shown and described above, it will be apparent to those skilled in the art that modifications and variations could be made without departing from the scope of the present disclosure as defined by the appended claims.

What is claimed is:

1. A multilayer electronic component comprising:
a body including a dielectric layer containing dielectric grains, an internal electrode, and a capacitance-forming portion in which the dielectric layer and the internal electrode are stacked to form capacitance; and
an external electrode disposed on the body and connected to the internal electrode,
wherein the dielectric grains include first grains having an aspect ratio of less than 1:5 and second grains having an aspect ratio of 1:5 or more, and
an area ratio of the second grains of the dielectric grains to the total area in the capacitance-forming portion is 0.07 or more and 0.99 or less.

2. The multilayer electronic component of claim 1, wherein a degree of orientation of the dielectric grains for a specific crystal plane is 30% or more.

3. The multilayer electronic component of claim 2 wherein the specific crystal plane is one of a (00l) plane, a (010) plane, an (111) plane, and a (100) plane.

4. The multilayer electronic component of claim 1, wherein the second crystal grain includes a core having an aspect ratio of 1:5 or more and a shell disposed on the core.

5. The multilayer electronic component of claim 4, wherein the core is formed of a single crystal.

6. The multilayer electronic component of claim 4, wherein the core comprises one of BaTiO₃ K_{0.5}Na_{0.5}NbO₃ Bi₄Ti₃O₁₂ Bi_{0.5}Na_{0.5}TiO₃ Na_{0.5}Bi_{4.5}Ti₄O₁₅ and Pb(Zr,Ti)O₃ as a main component.

7. The multilayer electronic component of claim 6, wherein the core further comprises at least one of Li, Ca, Al, Cu, Zr, Dy, Y, Tb, and Si.

8. The multilayer electronic component of claim 5, wherein the core further comprises at least one of Li, Ca, Al, Cu, Zr, Dy, Y, Tb, and Si, and
a content of at least one of Li, Ca, Al, Cu, Zr, Dy, Y, Tb, and Si in the core is 0.5 mol or less relative to 100 mol of the main component.

9. The multilayer electronic component of claim 4, wherein an average angle between the internal electrode and a major axis of the core is 80 degrees or more and 100 degrees or less.

10. The multilayer electronic component of claim 4, wherein the core is spaced apart from the first grains.

11. The multilayer electronic component of claim 4, wherein an average length of a major axis of the core is 0.05 µm or more and 5 µm or less.

12. The multilayer electronic component of claim 1, wherein the first grains comprise BaTiO₃ as a main component.

13. The multilayer electronic component of claim 1, wherein the first grains further comprise at least one of Li, Ca, Al, Cu, Zr, Dy, Y, Tb, and Si.

14. A multilayer electronic component comprising:
a body including a dielectric layer containing dielectric grains, an internal electrode, and a capacitance-forming portion in which the dielectric layer and the internal electrode are stacked in a first direction to form capacitance; and
a first external electrode and a second external electrode disposed on the body, connected to the internal electrode, and spaced apart from each other in a second direction,
wherein the dielectric grains include a second grain including a core formed of a single crystal and a shell disposed on the core, and a first grain not including the core, a crystal growth direction of the shell being substantially the same as a crystal growth direction of the core, and
an area ratio of the second grain per unit area of the dielectric grains in the capacitance-forming portion is 0.07 or more and 0.99 or less.

15. The multilayer electronic component of claim 14, wherein, when a dielectric layer included in the capacitance-forming portion is converted into an inverse pole figure (IPF) map through Electron Backscatter Diffraction (EBSD) analysis in a cross section of the first and second directions of the body, a color code consistency between the core and the shell is 95% or more.

16. The multilayer electronic component of claim 1, wherein the area ratio of the second grains of the dielectric grains per unit area in the capacitance forming portion is 0.50 or more and 0.99 or less.

17. The multilayer electronic component of claim 4, wherein the core contains 0.1 mol or less of each of Li, Ca, Al, Cu, Zr, Dy, Y, Tb, and Si relative to 100 mol of the main component.
